(19) United States
(12) Patent Application Publication
(10) Pub. No.: US 2016/0335492 A1
(43) Pub. Date: Nov. 17, 2016

(54) OPTICAL APPARATUS AND LIGHTING DEVICE THEREOF

(71) Applicant: EVERREADY PRECISION IND. CORP., Kaohsiung City (TW)

(72) Inventors: Jyh-Long CHERN, Taipei City (TW); Chih-Ming YEN, New Taipei City (TW)

(21) Appl. No.: 15/067,797

(22) Filed: Mar. 11, 2016

(30) Foreign Application Priority Data
May 15, 2015 (CN) 201510249502.2
May 15, 2015 (TW) 104115677

(51) Int. Cl. G06K 9/00; G01C 3/08; H04N 13/02

(52) U.S. Cl. CPC G06K 9/00389; H04N 13/0203; G01C 3/08

(57) ABSTRACT

An optical apparatus includes a lighting device and a sensing unit. The lighting device projects a first structured light and a second structured light on an under-test object. Consequently, at least one first pattern of a first pattern set corresponding to the first structured light and at least one second pattern of a second pattern set corresponding to the second structured light are shown on the under-test object. The direction of a second optical axis of the second structured light and the direction of a first optical axis of the first structured light are different. The sensing unit senses the at least one first pattern and the at least one second pattern on the under-test object. According to the relative position relationship between the first pattern and the second pattern, spatial information including a depth distance of the under-test object is obtained.

### FIELD OF THE INVENTION

The present invention relates to an optical apparatus and a lighting device thereof, and more particularly to an optical apparatus for a portable electronic device and a lighting device thereof.

### BACKGROUND OF THE INVENTION

Recently, with the progress of electronic industries and the advance of industrial technologies, various electronic devices are designed toward small size, light weight and stress-free portability. Consequently, these electronic devices can be applied to mobile business, entertainment or the domains of leisure purposes whenever or wherever the users are. For example, various imaging devices are widely used in many kinds of fields such as smart phones, wearable electronic devices or any other appropriate electronic devices. Since the imaging devices are small and portable, the users can bring the imaging devices personally and capture images and store the images according to the users' needs. Alternatively, the images can be uploaded to the internet or wirelessly through mobile networks. In other words, these electronic devices not only have important commercial values but also provide more colorful lives to human.

On the other hand, with the improvement of the living quality, people's demands on more functions of the imaging devices are progressively amplified. For example, many people are willing to acquire 3D images or spatial information which is beyond common image taken by common camera. Indeed, a good 3D image contains the accurate depth information. It is not too surprising that many people are willing to acquire the portable electronic devices with the distance measuring functions in order to recognize hand gestures. Technically, generally the depth information or the distance can be measured by a time-of-flight (TOF) measurement method, a single structured light measurement method or a dual camera distance measurement method. These methods are well known to those skilled in the art, and are not redundantly described herein.

As known, the measured result of the TOF measurement method has good accuracy. However, when the TOF measurement method is expanded to the planar scenario application or the multi-point scenario application, the software computing technology is very complicated. Moreover, the additional uses of the specified computing chip and integrated circuits require lot of power consumption and high computing cost. Moreover, the TOF measurement method is readily affected by the ambient brightness. If the light pollution in the surroundings is serious, the accuracy of the measured result is low. The software computing technology for the dual camera distance measurement method is somewhat complicated and not easier. Moreover, since the dual camera distance measurement method uses two cameras, the dual camera distance measurement method are advantageous over the TOF measurement method in power consumption and computing cost. However, the performance of measuring the distance from the smooth surface of the dual camera distance measurement method in inferior to the TOF measurement method, the measured result about the distance from the smooth surface has lower accuracy. Moreover, since the single structured light measurement method acquires the depth information or the distance information according to the optical distortion of the image, the measured result is also readily affected by the ambient brightness. That is, if the light pollution in the surroundings is serious, the accuracy of the measured result is low or even could be not available.

From the discussions shown above, the conventional portable electronic devices and their imaging devices (optical apparatuses) for acquiring the depth information of the 3D images, reconstructing the 3D images or measuring the distances to recognize hand gestures still need to be improved.

### SUMMARY OF THE INVENTION

An object of the present invention provides an optical apparatus using at least two structured lights to measure the distance (i.e. the depth distance) of an under-test object. The present invention also provides a lighting device of the optical apparatus. By the optical apparatus, the accuracy of measuring distances is increased, and the measured result is not readily affected by the ambient brightness.

In accordance with an aspect of the present invention, there is an optical apparatus to be provided to solve the issues highlighted above. The optical apparatus includes a first structured light generation unit and a second structured light generation unit. The first structured light generation unit provides a first structured light. When the first structured light is projected on an under-test object, at least one first pattern of a first pattern set corresponding to the first structured light is shown on the under-test object. The second structured light generation unit provides a second structured light. When the second structured light is projected on the under-test object, at least one second pattern of a second pattern set corresponding to the second structured light is shown on the under-test object. A direction of a second optical axis of the second structured light is different from a direction of a first optical axis of the first structured light. There is at least one relative position relationship between the at least one first pattern and the at least one second pattern. Moreover, at least one depth distance of the under-test object is obtained according to at least one relative position relationship.

In an embodiment, the first structured light generation unit includes a first light source and a first lens group corresponding to the first pattern set, and the second structured light generation unit includes a second light source and a second lens group corresponding to the second pattern set.

In an embodiment, the first light source includes a laser diode, a light emitting diode and/or an organic light emitting diode;, and/or the first light source emits light beams in a thermal band; and/or the second light source includes a laser diode, a light emitting diode and/or an organic light emitting diode; and/or the second light source emits light beams in a thermal band; and/or the optical apparatus further includes a casing, wherein at least one of the first structured light generation unit and the second structured light generation unit is disposed within the casing, and the casing is a surface mount device.

In an embodiment, the first light source emits light beams in a first wavelength range and/or light beams in a second wavelength range.

In an embodiment, the light beams in the first wavelength range are visible light beams, and the light beams in the second wavelength range are invisible light beams.

In an embodiment, the second light source emits light beams in a first wavelength range and/or light beams in a second wavelength range.

In an embodiment, the light beams in the first wavelength range are visible light beams, and the light beams in the second wavelength range are invisible light beams.

In an embodiment, the first structured light has a first cone shape, and the second structured light has a second cone shape.

In an embodiment, the first cone shape is a circular cone shape, an elliptical cone shape or a square cone shape; and/or the second cone shape is a circular cone shape, an elliptical cone shape or a square cone shape.

In an embodiment, the at least one first pattern includes at least one point pattern; and/or the at least one second pattern includes at least one line pattern or at least one rectangle pattern.

In an embodiment, the first structured light is generated at a time slot different from that of the second structured light. That is the structure light patterns are generated according to different time sequences.

In accordance with another aspect of the present invention, there is provided an optical apparatus. The optical apparatus includes a lighting device and a sensing unit. The lighting device provides a first structured light and a second structured light. When the first structured light is projected on an under-test object, at least one first pattern of a first pattern set corresponding to the first structured light is shown on the under-test object. When the second structured light is projected on an under-test object, at least one second pattern of a second pattern set corresponding to the second structured light is shown on the under-test object. A direction of a second optical axis of the second structured light is different from a direction of a first optical axis of the first structured light. The sensing unit senses the at least one first pattern and the at least one second pattern on the under-test object. There is at least one relative position relationship between the at least one first pattern and the at least one second pattern. Moreover, at least one depth distance of the under-test object is obtained according to at least one relative position relationship.

In an embodiment, the lighting device includes at least one light source, a first lens group corresponding to the first pattern set and a second lens group corresponding to the second pattern set. After plural first light beams outputted from the at least one light source pass through the first lens group, the first structured light is generated. After plural second light beams outputted from the at least one light source pass through the second lens group, the second structured light is generated.

In an embodiment, the at least one light source includes a laser diode, a light emitting diode and/or an organic light emitting diode; and/or the at least one light source emits light beams in a thermal band.

In an embodiment, the plural first light beams have wavelength in a first wavelength range and/or in a second wavelength range.

In an embodiment, the plural second light beams have wavelength in a first wavelength range and/or in a second wavelength range.

In an embodiment, the first structured light has a first cone shape, and the second structured light has a second cone shape.

In an embodiment, the first cone shape is a circular cone shape, an elliptical cone shape or a square cone shape; and/or the second cone shape is a circular cone shape, an elliptical cone shape or a square cone shape.

In an embodiment, the at least one first pattern includes at least one point pattern; and/or the at least one second pattern includes at least one line pattern or at least one rectangle pattern.

In an embodiment, the first structured light is generated at a time slot different from that of the second structured light. That is the structure light patterns are generated according to different time sequences.

In an embodiment, the lighting device and the sensing unit are integrally installed on the same printed circuit board.

In an embodiment, the optical apparatus is included in a portable electronic device.

From the above descriptions, the optical apparatus of the present invention uses two structured lights to measure the distance (i.e. the depth distance) of the under-test object. The accuracy of measuring distances is increased, and the measured result is not readily affected by the ambient brightness. When the optical apparatus is applied to a portable electronic device, the portable electronic device is capable of capturing 3D images, reconstructing 3D images with much more complete spatial information, and recognizing hand gestures.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the structure of an optical apparatus according to an embodiment of the present invention;

FIG. 2 schematically illustrates the lighting device, the first structured light and the second structured light of the optical apparatus of FIG. 1 and taken along another viewpoint;

FIG. 3 schematically illustrates first patterns and second patterns on an under-test object when the first structured light and the second structured light are projected on the under-test object;

FIG. 4A schematically illustrates an image captured by the sensing unit, in which the under-test object is at a first position of the overlap region between the first structured light and the second structured light;

FIG. 4B schematically illustrates an image captured by the sensing unit, in which the under-test object is at a second position of the overlap region between the first structured light and the second structured light; and

FIG. 5 schematically illustrates a portable electronic device with the optical apparatus of the present invention.

### DETAILED DESCRIPTION OF THE PREFERRED EMBODIMENT

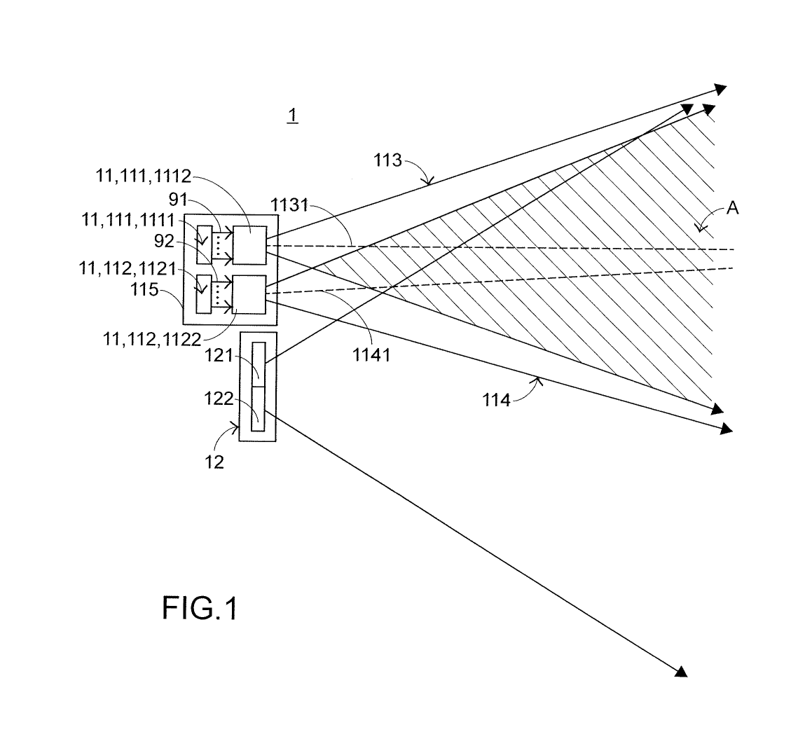

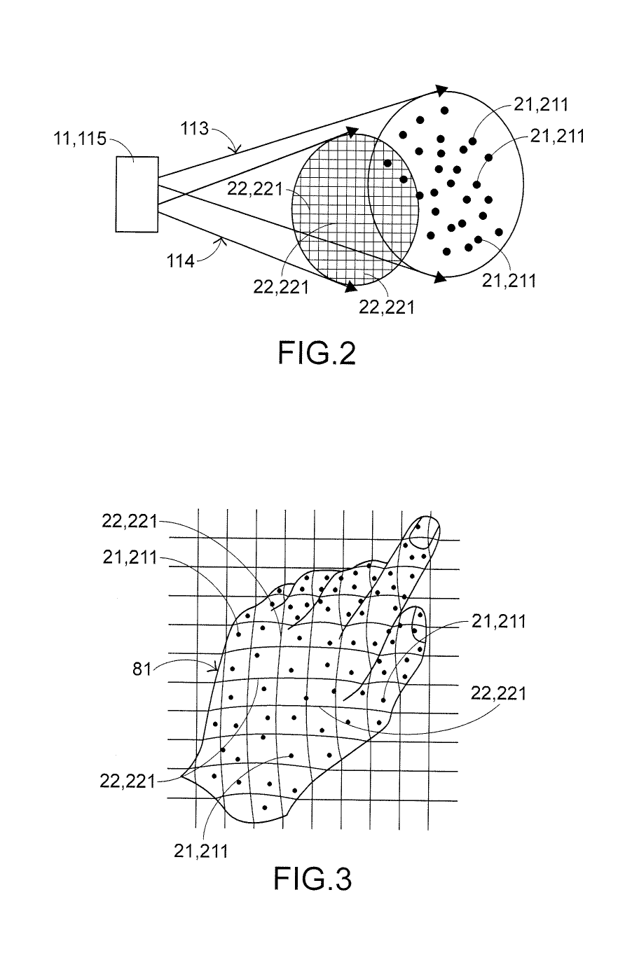

FIG. 1 schematically illustrates the structure of an optical apparatus according to an embodiment of the present invention. FIG. 2 schematically illustrates the lighting device, the first structured light and the second structured light of the optical apparatus of FIG. 1 and taken along another viewpoint. FIG. 3 schematically illustrates first patterns and second patterns on an under-test object when the first structured light and the second structured light are projected on the under-test object.

The optical apparatus 1 comprises a lighting device 11 and a sensing unit 12. The lighting device 11 is used for generating a first structured light 113 and a second structured light 114. When the first structured light 113 is projected on the under-test object 81, at least one first pattern 211 of a first pattern set 21 is shown on the under-test object 81. When the second structured light 114 is projected on the under-test object 81, at least one second pattern 221 of a second pattern set 22 is shown on the under-test object 81. In this embodiment, the direction of an optical axis 1131 (first optical axis) of the first structured light 113 and the direction of an optical axis (second optical axis) of the second structured light 114 are different.

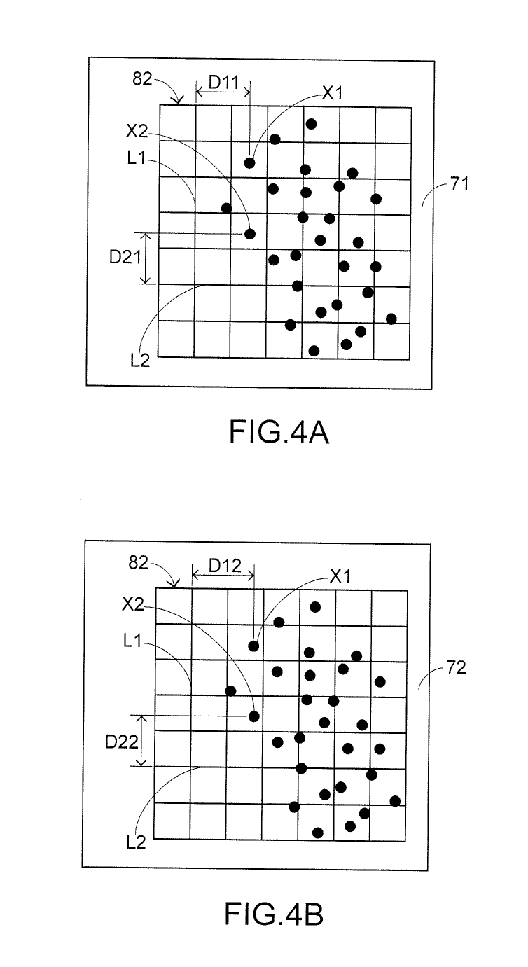

The sensing unit 12 comprises a visible light sensor 121 and an invisible light sensor 122 for sensing the at least one first pattern 211 and the at least one second pattern 221 that are shown on the under-test object 81. There is at least one relative position relationship between the at least one first pattern 211 and the at least one second pattern 221 that are shown on the under-test object 81. According to the at least one relative position relationship, at least one depth distance of the under-test object 81 can be acquired. The way of acquiring the at least one depth distance of the under-test object 81 according to the at least one relative position relationship will be illustrated with reference to FIGS. 3, 4A and 4B.

In this embodiment, the lighting device 11 comprises a first structured light generation unit 111 and a second structured light generation unit 112. The first structured light generation unit 111 comprises a first light source 1111 and a first lens group 1112. The first light source 1111 comprises a laser diode (LD), a light emitting diode (LED), an organic light emitting diode (OLED), and/or or any other comparable semiconductor-type light-emitting element similar to the laser diode, the light emitting diode or the organic light emitting diode. The first light source 1111 is used for emitting plural light beams 91. The wavelengths of the light beams 91 are in a first wavelength range (e.g., visible light beams) and/or a second wavelength range (e.g., invisible beams or light beams in a thermal band). The first lens group 1112 at least comprises an optical component corresponding to the first pattern set 21. For example, the optical component is a diffractive optical element (not shown). After the light beams 91 from the first light source 1111 pass through the optical component, the first structured light 113 containing the first pattern set 21 is generated by the first structured light generation unit 111. The first structured light 113 has a first cone shape.

In this embodiment, the first cone shape of the first structured light 113 is a circular cone shape. In some other embodiments, the first cone shape of the first structured light 113 is an elliptical cone shape or a square cone shape. The above way of generating the first structured light 113 by the first lens group 1112 and the optical component is presented herein for purpose of illustration and description only. The technology of generating the first structured light 113 is well known to those skilled in the art, and is not redundantly described herein. Moreover, the method of generating the first structured light 113 is not restricted.

The second structured light generation unit 112 comprises a second light source 1121 and a second lens group 1122. The second light source 1121 comprises a laser diode (LD), a light emitting diode (LED), an organic light emitting diode (OLED), and/or or any other comparable semiconductor-type light-emitting element similar to the laser diode, the light emitting diode or the organic light emitting diode. The second light source 1121 is used for emitting plural light beams 92. The wavelengths of the light beams 92 are in a third wavelength range (e.g., visible light beams) and/or a fourth wavelength range (e.g., invisible beams or light beams in a thermal band). The second lens group 1122 at least comprises an optical component corresponding to the second pattern set 22. For example, the optical component is a diffractive optical element (not shown). After the light beams 92 from the second light source 1121 pass through the optical component, the second structured light 114 containing the second pattern set 22 is generated by the second structured light generation unit 112. The second structured light 114 has a second cone shape.

In this embodiment, the second cone shape of the second structured light 114 is a circular cone shape. In some other embodiments, the second cone shape of the second structured light 114 is an elliptical cone shape or a square cone shape. The above way of generating the second structured light 114 by the second lens group 1122 and the optical component is presented herein for purpose of illustration and description only. The technology of generating the second structured light 114 is well known to those skilled in the art, and is not redundantly described herein. Moreover, the method of generating the second structured light 114 is not restricted.

It is noted that the number of the light sources, the number of the lens groups and the number of the sensing units may be altered according to the practical requirements. For example, the optical apparatus comprises plural sensing units for receiving the light beams with different wavelengths and/or from different positions and directions. Alternatively, in another embodiment, the first light source 1111 and the second light source 1121 are the same light source. Moreover, the lighting device 11 further comprises a SMD (surface mount device) casing 115. The first light source 1111, the first lens group 1112, the second light source 1121 and/or the second lens groups 1122 are fixed within the casing 115. Consequently, the reliability of the lighting device 11 is enhanced and the protecting purpose is achieved. In some embodiments, the lighting device 11 and the sensing unit 12 are integrally installed on the same printed circuit board (PCB).

Hereinafter, the operating principles of measuring the distance (i.e., a depth distance) by using the first structured light 113 and the second structured light 114 will be illustrated with reference to FIGS. 1 and 2. As shown in FIG. 2, the first pattern set 21 corresponding to the first structured light 113 comprises plural first patterns 211 (i.e., plural dot patterns), and the second pattern set 22 corresponding to the second structured light 114 comprises plural second patterns 212 (i.e., plural rectangle patterns composed of plural longitudinal/transverse lines). As mentioned above, the direction of an optical axis 1131 (first optical axis) of the first structured light 113 and the direction of an optical axis (second optical axis) of the second structured light 114 are different. Consequently, an overlap region A (i.e., the regions marked with oblique lines) is formed between the first cone-shaped first structured light 113 and the second cone-shaped second structured light 114. In case that the under-test object 81 is located in the overlap region A, at least a portion of the first pattern set 21 and at least a portion of the second pattern set 22 are shown on the under-test object 81. The at least relative position relationship between the at least one first pattern 211 and the at least one second pattern 221 on the under-test object 81 may be changed according to the positions. According to the change of the at least relative position relationship, the depth distance of the under-test object 81 can be estimated quickly and precisely.

FIG. 4A schematically illustrates an image captured by the sensing unit, in which the under-test object is at a first position of the overlap region between the first structured light and the second structured light. FIG. 4B schematically illustrates an image captured by the sensing unit, in which the under-test object is at a second position of the overlap region between the first structured light and the second structured light. For illustration, the under-test object 82 shown in FIG. 4A and the under-test object 82 shown in FIG. 4B are the same planar-type under-test object. In case that the under-test object 82 is at the same position, the distances between all blocks of the under-test object 82 and the sensing unit 12 are substantially equal. As shown in FIGS. 4A and 4B, the relative position relationships between the plural first patterns 211 (i.e., the plural point patterns) and the plural second patterns 221 (i.e., the plural line patterns) corresponding to the first position and the second position of the under-test object 82 are different.

For example, in case that the under-test object 82 is located at the first position of the overlap region A between the first structured light 113 and the second structured light 114, an image 71 is captured by the sensing unit 12. In the image 71, the distance between the point pattern X1 and the line pattern L1 of the under-test object 82 is D11, and the distance between the point pattern X2 and the line pattern L2 of the under-test object 82 is D21. In case that the under-test object 82 is located at the second position of the overlap region A between the first structured light 113 and the second structured light 114, an image 72 is captured by the sensing unit 12. In the image 72, the distance between the point pattern X1 and the line pattern L1 of the under-test object 82 is D12, and the distance between the point pattern X2 and the line pattern L2 of the under-test object 82 is D22. The distance D11 and the distance D12 are different, and the distance D12 and the distance D22 are different. According to the distance D11, the distance D21 and/or another distance between another point pattern and another line pattern corresponding to the first position of the under-test object 82, the depth distance of the first position can be estimated. For example, the depth distance of the first position can be estimated through a look-up table. Similarly, according to the distance D12, the distance D22 and/or another distance between another point pattern and another line pattern corresponding to the second position of the under-test object 82, the depth distance of the second position can be estimated quickly. For example, the depth distance of the second position can be estimated through a look-up table. Moreover, the difference between the depth distance of the first position and the depth distance of the second position can be obtained accordingly.

The similar operating principles can be applied to the example of FIG. 3. As shown in FIG. 3, the under-test object 81 is a hand. In case that the hand has a specified gesture, the distances between all blocks of the hand and the sensing unit 12 are not always identical. As mentioned above, after the image of the under-test object 81 is captured, plural first patterns 211 and plural second patterns 221 on the under-test object 81 can be acquired. Moreover, according to the relative position relationships between the plural first patterns 211 and the plural second patterns 221, the depth distances of all blocks of the hand can be acquired. The size of each block of the hand (i.e., the resolving power) is dependent on the profiles of the first patterns 211 and/or the profiles of the second patterns 221. For example, in case that the distance between the line pattern and the line pattern is smaller and/or the distance between the point pattern and the point pattern is smaller, each block of the hand is resolved more precisely.

In other embodiment, the first structured light may be generated at a time slot which is different from that of the second structured light. This is the structure light patterns are generated according to different time sequences.

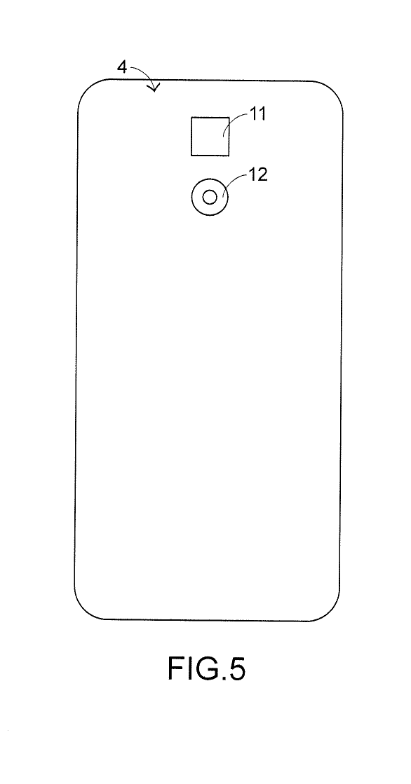

FIG. 5 schematically illustrates a portable electronic device with the optical apparatus of the present invention. An example of the portable electronic device 4 includes but is not limited to a mobile phone, a tablet computer or a wearable device. The portable electronic device 4 comprises a lighting device 11 and a sensing unit 12. The structures and functions of the lighting device 11 and the sensing unit 12 are identical to those mentioned above, and are not redundantly described herein. Consequently, the portable electronic device 4 is capable of capturing 3D images, reconstructing 3D images and recognizing hand gestures. As mentioned above, the optical apparatus 1 of this embodiment can measure distances accurately. In addition, the measured result is not readily affected by the ambient brightness. Consequently, the optical apparatus of the present invention is beneficial to the portable electronic device 4.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. An optical apparatus, comprising:
a first structured light generation unit providing a first structured light, wherein when the first structured light is projected on an under-test object, at least one first pattern of a first pattern set corresponding to the first structured light is shown on the under-test object; and
a second structured light generation unit providing a second structured light, wherein when the second structured light is projected on the under-test object, at least one second pattern of a second pattern set corresponding to the second structured light is shown on the under-test object, wherein a direction of a second optical axis of the second structured light is different from a direction of a first optical axis of the first structured light,
wherein there is at least one relative position relationship between the at least one first pattern and the at least one second pattern, and at least one depth distance of the under-test object is obtained according to at least one relative position relationship.

2. The optical apparatus according to claim 1, wherein the first structured light generation unit comprises a first light source and a first lens group corresponding to the first pattern set, and the second structured light generation unit comprises a second light source and a second lens group corresponding to the second pattern set.

3. The optical apparatus according to claim 2, wherein
the first light source comprises a laser diode, a light emitting diode and/or an organic light emitting diode; and/or
the first light source emits light beams in a thermal band; and/or
the second light source comprises a laser diode, a light emitting diode and/or an organic light emitting diode; and/or
the second light source emits light beams in a thermal band; and/or
the optical apparatus further comprises a casing, wherein at least one of the first structured light generation unit and the second structured light generation unit is disposed within the casing, and the casing is a surface mount device.

4. The optical apparatus according to claim 2, wherein the first light source emits light beams in a first wavelength range and/or light beams in a second wavelength range.

5. The optical apparatus according to claim 4, wherein the light beams in the first wavelength range are visible light beams, and the light beams in the second wavelength range are invisible light beams.

6. The optical apparatus according to claim 2, wherein the second light source emits light beams in a first wavelength range and/or light beams in a second wavelength range.

7. The optical apparatus according to claim 6, wherein the light beams in the first wavelength range are visible light beams, and the light beams in the second wavelength range are invisible light beams.

8. The optical apparatus according to claim 1, wherein the first structured light has a first cone shape, and the second structured light has a second cone shape.

9. The optical apparatus according to claim 8, wherein the first cone shape is a circular cone shape, an elliptical cone shape or a square cone shape; and/or the second cone shape is a circular cone shape, an elliptical cone shape or a square cone shape.

10. The optical apparatus according to claim 1, wherein the at least one first pattern comprises at least one point pattern; and/or the at least one second pattern comprises at least one line pattern or at least one rectangle pattern.

11. The optical apparatus according to claim 1, wherein at least one first structured light is generated at a time slot different from that of one second structured light.

12. An optical apparatus, comprising:
a lighting device providing a first structured light and a second structured light, wherein when the first structured light is projected on an under-test object, at least one first pattern of a first pattern set corresponding to the first structured light is shown on the under-test object, wherein when the second structured light is projected the an under-test object, at least one second pattern of a second pattern set corresponding to the second structured light is shown on the under-test object, wherein a direction of a second optical axis of the second structured light is different from a direction of a first optical axis of the first structured light; and
a sensing unit sensing the at least one first pattern and the at least one second pattern on the under-test object,
wherein there is at least one relative position relationship between the at least one first pattern and the at least one second pattern, and at least one depth distance of the under-test object is obtained according to at least one relative position relationship.

13. The optical apparatus according to claim 12, wherein the lighting device comprises at least one light source, a first lens group corresponding to the first pattern set and a second lens group corresponding to the second pattern set, wherein after plural first light beams outputted from the at least one light source pass through the first lens group, the first structured light is generated, wherein after plural second light beams outputted from the at least one light source pass through the second lens group, the second structured light is generated.

14. The optical apparatus according to claim 13, wherein the at least one light source comprises a laser diode, a light emitting diode and/or an organic light emitting diode;
and/or the at least one light source emits light beams in a thermal band.

15. The optical apparatus according to claim 13, wherein the plural first light beams have wavelength in a first wavelength range and/or in a second wavelength range.

16. The optical apparatus according to claim 13, wherein the plural second light beams have wavelength in a first wavelength range and/or in a second wavelength range.

17. The optical apparatus according to claim 12, wherein the first structured light has a first cone shape, and the second structured light has a second cone shape.

18. The optical apparatus according to claim 17, wherein the first cone shape is a circular cone shape, an elliptical cone shape or a square cone shape; and/or the second cone shape is a circular cone shape, an elliptical cone shape or a square cone shape.

19. The optical apparatus according to claim 12, wherein the at least one first pattern comprises at least one point pattern; and/or the at least one second pattern comprises at least one line pattern or at least one rectangle pattern.

20. The optical apparatus according to claim 12, wherein the lighting device and the sensing unit are integrally installed on the same printed circuit board.

21. The optical apparatus according to claim 12, wherein the optical apparatus is included in a portable electronic device.

22. The optical apparatus according to claim 12, wherein at least one first structured light is generated at a time slot different from that of one second structured light.
